(19) United States
(12) Patent Application Publication
(10) Pub. No.: US 2015/0170549 A1
(43) Pub. Date: Jun. 18, 2015

(54) FIXED-STAR PROJECTION CYLINDER

(71) Applicant: Kabushikigaisha Goto Kogaku Kenkyusho, Tokyo (JP)

(72) Inventor: Makoto Kasahara, Fuchu-shi (JP)

(73) Assignee: Kabushikigaisha Goto Kogaku Kenkyusho, Tokyo (JP)

(21) Appl. No.: 14/355,263

(22) PCT Filed: Jan. 31, 2014
(86) PCT No.: PCT/JP2014/052816

§ 371 Date: Feb. 26, 2015

(30) Foreign Application Priority Data
Nov. 30, 2013 (JP) 2013-248773

(51) Int. Cl. G09B 27/04

(52) U.S. Cl. CPC G09B 27/04

(57) ABSTRACT

A fixed-star projection cylinder capable of reproducing a color unique to each fixed star for reproduction of situation of real starlit sky is provided.

In a fixed-star projection cylinder for a planetarium to project fixed stars shown in a fixed-star template 2 as fixed-star images onto a screen, a spectral type is defined for each individual fixed star on the fixed-star template, and light emitted from a plurality of light sources 5 differing in color temperature or color tone are guided to corresponding individual fixed stars by light guiding means 4 such that the colors based on the defined spectral types can be reproduced in projection.

### TECHNICAL FIELD

This invention relates to a fixed-star projection cylinder used in a planetarium or the like.

### BACKGROUND ART

For projection of all-sky fixed stars in a planetarium, the all sky is divided into a plurality of images and the divided images are projected respectively by a plurality of fixed-star projection cylinders each of which includes a projection template and a projection lens.

On the other hand, the use of an optical fiber to guide light from a light source to a fixed-star projection cylinder is well known (Patent Literatures 1, 2, 3).

Patent Literature 1 discloses a planetarium for projecting an individual fixed-star image onto a screen through a projection lens by emitting light from en end face of an individual optical fiber arranged corresponding to a position of a fixed star.

Patent literature 2 discloses a planetarium having a fixed-star projection cylinder which sends light guided into the fixed-star projection cylinder by an optical fiber to a condenser lens in order to illuminate a projection template perforated for a plurality of fixed-star images, and a high-intensity fixed-star projection cylinder which illuminates a projection template perforated for a single fixed-star image with light guided into the projection cylinder by an optical fiber.

In the known techniques disclosed in the above patent literatures, since all the optical fibers guide light from a shared light source, the color of the fixed stars projected on a screen is single. However, in the case of providing a high-intensity fixed-star projection cylinder such as in the planetarium disclosed by patent Literature 2, by changing the color of the light source of the optical fiber guiding the light into the high-intensity fixed-star projection cylinder, only a high-visibility, bright star is represented in the color of the fixed star. On the other hand, in the fixed-star projection cylinder which sending the light guided into the fixed-star projection cylinder by the optical fiber to the condenser lens to illuminates the projection template perforated for a plurality of fixed-star images, the color of the fixed star projected on the screen is unavoidably single.

Next, Patent Literature 3 discloses a planetarium in which an optical fiber plate which is an optical member including a bundle of optical fibers is placed such that the light exit side of the optical fiber plate faces a projection lens, a transmissive liquid crystal panel and an imaging lens are placed between a light source and an input end face of the optical fiber plate, and light passing through a pixel of the transmissive LC panel in a fixed star image generated on the transmissive LC panel is allowed to enter only one optical fiber.

### CITATION LIST

### Patent Literature

Patent Literature 1: JP-A No. S62-191818

### Patent Literature 2: JP-A No. 2001-109063

### Patent Literature 3: JP-A No. 2009-237481

### SUMMARY OF INVENTION

### Technical Problem

As described above, in typical planetariums, only a high-visibility, bright star is represented by use of a color of the star. This is because the structure of the fixed-star cylinder makes it difficult to reproduce individual star colors for 10,000 stars which are observable with the naked eye.

Therefore, a starlit sky made out of fixed stars with various colors responsive to color temperatures of the respective fixed stars is projected by merely coloring only high-visibility, bright stars, thus differing considerably from the situation of zeal starlit sky.

### Solution to Problem

The present invention has been made in light of the aforementioned disadvantage in the related art, and accordingly an object of the present invention is to provide a fixed-star projection cylinder capable of reproducing a color unique to each fixed star for reproduction of situation of real starlit sky, although only a color unique to a specific bright fixed star is reproduced in the related art.

In a fixed-star projection cylinder according to the present invention, luminous fluxes having a plurality of color temperatures or color tones matched to color temperatures of individual fixed stars to be projected are generated. Since such a luminous flux is typically diffused light, the lights having the colors are mixed up before they reach a projection lens, making it impossible to add an individual color or color tone to each fixed star. To avoid this, light guiding means such as an optical fiber or the like is used to guide light of an individual color directly to a position of a fixed star having a corresponding spectral type on the fixed-star template or a position in which a corresponding fixed star should be located. This makes it possible to add light of an appropriate color to the fixed star.

In other words, a difference between the fixed-star projection cylinder according to the present invention and the fixed-star projection cylinders in the related art is that individual light guiding means is provided for each individual fixed star to be projected, and the light emitted from the light guiding means is designed to have a color based on the spectral type of the fixed star to be projected.

The fixed-star projection cylinder for a planetarium described in claim 1 is to project individual fixed-star images onto a screen through a projection lens by either light traveling from exit end faces of individual light guiding means to pass through individual light transmissive portions of a fixed-star projection template arranged corresponding to positions of fixed stars or light traveling from exit end faces of individual light guiding means arranged corresponding to positions of fixed stars. In the fixed-star projection cylinder, a spectral type is defined for each individual fixed-star image to be projected. A plurality of types of light differing in either color temperature or color tone are emitted from the exit end faces of the individual light guiding means for reproduction of colors based on the defined spectral types in projection.

Further, the fixed-star projection cylinder described in claim 2 has a feature that, in the aforementioned fixed-star projection cylinder, optical fibers are used as the light guiding means.

Further, the fixed-star projection cylinder described in claim 3 has a feature that, in the aforementioned fixed-star projection cylinder, means is designed to guide lights emitted from a plurality of light sources with either different color temperatures or different color tones from the entry end faces of the individual light guiding means to emit a plurality of types of light with either different color temperatures or different color tones from the exit end faces of the individual light guiding means.

Further, the fixed-star projection cylinder described in claim 4 has a feature that, in the aforementioned fixed-star projection cylinder, a plurality of the light sources with either different color temperatures or different color tones are placed in the fixed-star projection cylinder.

Further, the fixed-star projection cylinder described in claim 5 has a feature that, in the aforementioned fixed-star projection cylinder, a plurality of the light sources with either different color temperatures or different color tones are placed outside the fixed-star projection cylinder.

Further, the fixed-star projection cylinder described in claim 6 has a feature that, in the aforementioned fixed-star projection cylinder, a single light source is shared among a plurality of the light guiding means assigned to the same color temperature or color tone of light to be emitted in either the same fixed-star projection cylinder or a different fixed-star projection cylinder.

Further, the fixed-star projection cylinder described in claim 7 has a feature that, in the aforementioned fixed-star projection cylinder, a plurality of luminous fluxes of either different color temperatures or different color tones are generated by combined colors of a plurality of different emission colors of the light sources.

Further, the fixed-star projection cylinder described in claim 8 has a feature that, in the aforementioned fixed-star projection cylinder, the fixed-star projection cylinder is capable of individually varying luminance intensities of a plurality of the light sources for creation of the combined colors.

Further, the fixed-star projection cylinder described in claim 9 has a feature that, in the aforementioned fixed-star projection cylinder, a filter for either passage or attenuation of light of a specific wavelength is placed between a light source and the entry end face of the light guiding means to serve as means for emitting a plurality of the types of light differing in either color temperature or color tone from the exit end faces of the individual light guiding means.

Further, the fixed-star projection cylinder described in claim 10 has a feature that, in the aforementioned fixed-star projection cylinder, a transmissive color liquid crystal panel is used as a filter for either passage or attenuation of light of a specific wavelength by controlling sets of nearby pixels on the transmissive color liquid crystal panel, each set of nearby pixels being assigned to a color.

Further, the fixed-star projection cylinder described in claim 11 has a feature that, in the aforementioned fixed-star projection cylinder, the fixed-star projection cylinder is capable of controlling transmittance of the sets of nearby pixels on the transmissive color liquid crystal panel as required.

### Advantageous Effects of Invention

Unlike the fixed-star projection cylinders in the related art, in a starlit sky reproduced by the fixed-star projection cylinder according to the present invention configured as described above, suitable colors corresponding to spectral types of fixed stars are added to all the fixed stars, making it possible to reproduce the same starlit sky as real night sky.

In this case, with the fixed-star projection cylinder described in claim 6, a light source is shared among a plurality of the light guiding means assigned to the same color temperature or color tone of light to be emitted in either the same fixed-star projection cylinder or a different fixed-star projection cylinder. Because of this, a reduction in the number of light sources can be achieved, eliminating a disadvantageous problem of occupying space in the fixed-star projection cylinder or the planetarium apparatus and a disadvantageous problem of extremely heat generation.

Also, with the fixed-star projection cylinder described in claim 9, since a filter for either passage or attenuation of light of a specific wavelength is placed between a light source and the entry end face of the light guiding means to serve as means for emitting a plurality of the types of light differing in either color temperature or color tone from the exit end faces of the individual light guiding means, the light source itself is for a single color, making it possible to further reduce the number of light sources.

### BRIEF DESCRIPTION OF DRAWINGS

FIG. 1 is a partial cut-away side view of a first embodiment of a fixed-star projection cylinder according to the present invention.

FIG. 2 is a partial cut-away side view of a second embodiment of a fixed-star projection cylinder according to the present invention.

FIG. 3 is a side view of the essential parts of a third embodiment of a fixed-star projection cylinder according to the present invention.

FIG. 4 is a side view of the essential parts of a fourth embodiment of a fixed-star projection cylinder according to the present invention.

FIG. 5 is a side view of the essential parts of a fifth embodiment of a fixed-star projection cylinder according to the present invention.

FIG. 6 is a side view of the essential parts of a sixth embodiment of a fixed-star projection cylinder according to the present invention.

FIG. 7 is a perspective view of the essential parts of the sixth embodiment of the fixed-star projection cylinder according to the present invention.

FIG. 8 is a side view of the essential parts of a seventh embodiment of a fixed-star projection cylinder according to the present invention.

FIG. 9 is a side view of the essential parts of an eighth embodiment of a fixed-star projection cylinder according to the present invention.

### DESCRIPTION OF EMBODIMENTS

Concrete exemplary embodiments of a fixed-star projection cylinder according to the present invention will be descried below with reference to the accompanying drawings.

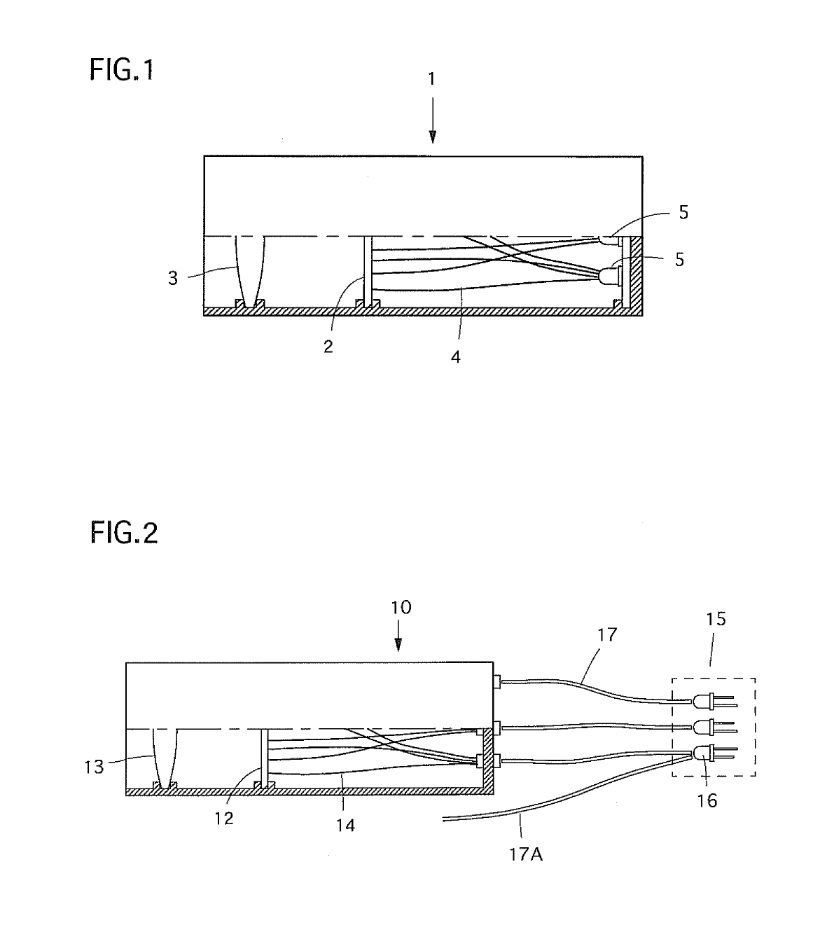

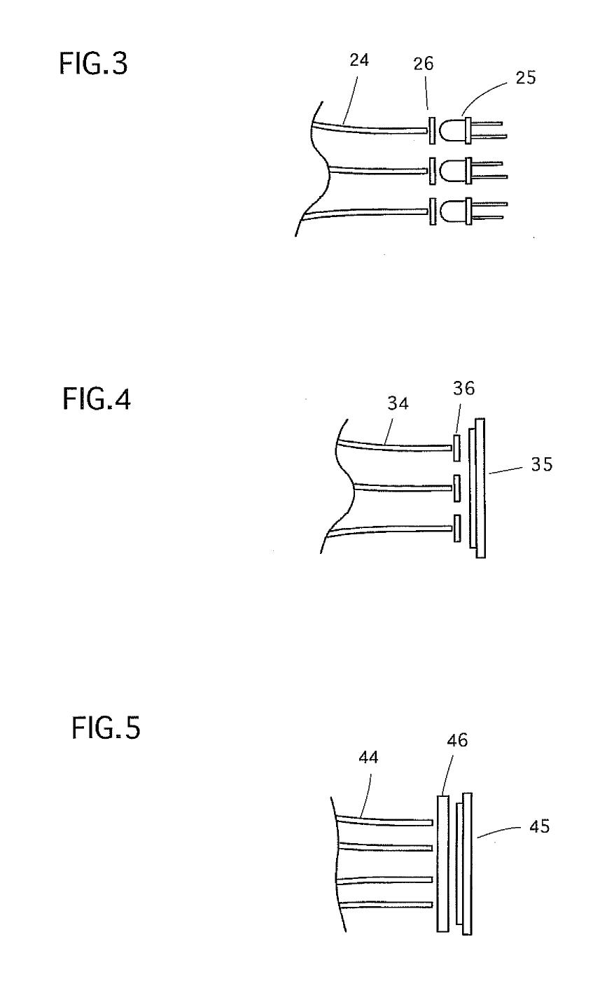

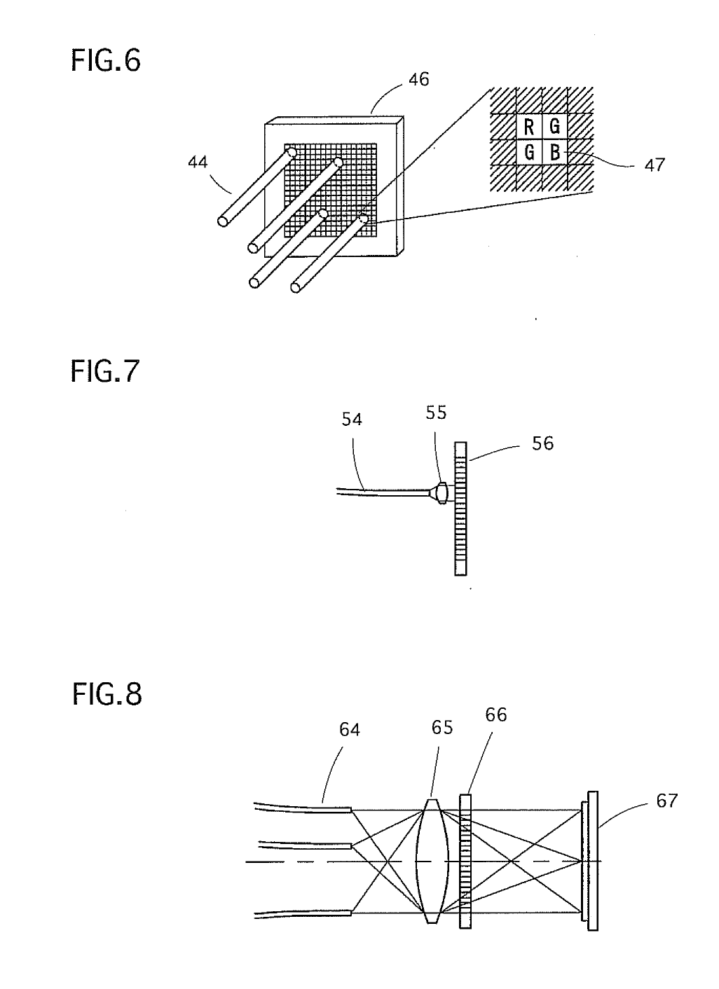

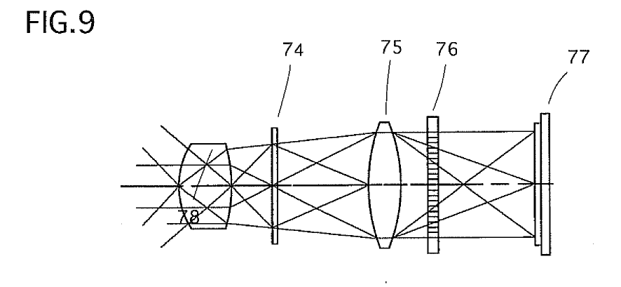

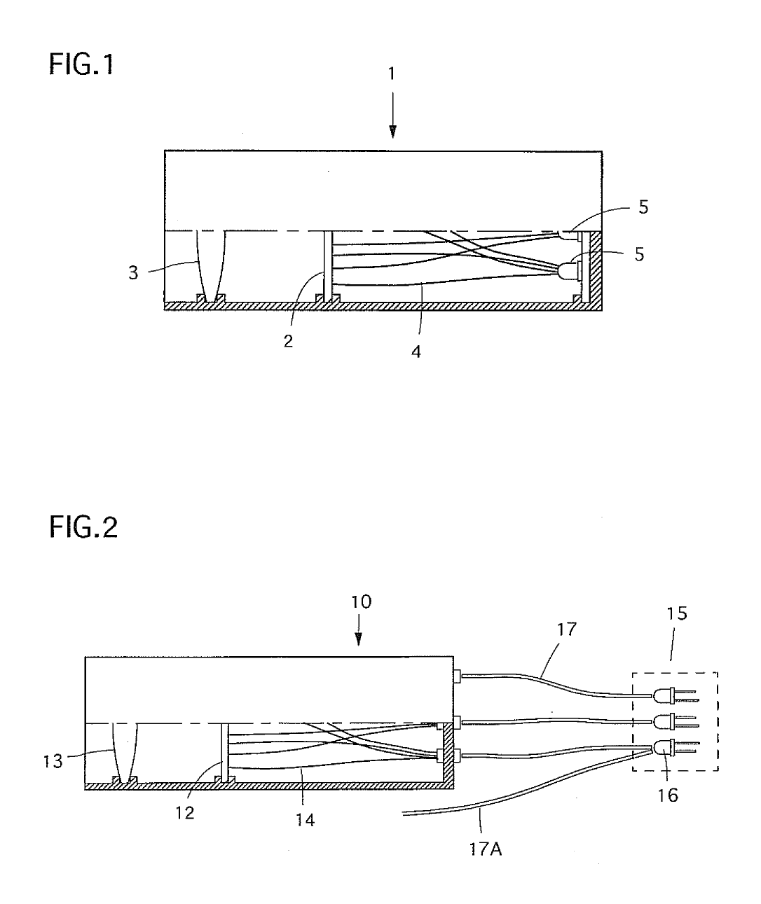

FIG. 1 is a view illustrating a first embodiment of a fixed-star projection cylinder according to the present invention. A fixed-star projection cylinder according to the present invention is a fixed-star projection cylinder for a planetarium to project individual fixed-star images onto a screen through a projection lens by light which travels from exit end faces of individual light guiding means to pass through individual light transmissive portions of a fixed-star projection template arranged corresponding to positions of fixed stars or light which travels from exit end faces of individual light guiding means arranged corresponding to positions of fixed stars, in which a spectral type is defined for each fixed-star image to be projected, and a plurality of types of light differing in color temperature or color tone are emitted from the exit end faces of the individual light guiding means so that colors based on the defined spectral types are reproduced in projection.

Here, 5 classes shown below is an example of the number of classes of colors of the fixed star images.

| Spectral Type of Fixed-Star | Color of Corresponding Light |
|---|---|
| Image | Source |
| O | Light blue |
| B, A | Cool white |
| F, G | Warm white |
| K | Yellow |
| M | Orange |

In the embodiment, means is designed to guide lights emitted from a plurality of light sources with different color temperatures or color tones from the entry end faces of the individual light guiding means to emit a plurality of types of light with different color temperatures or color tones from the exit end faces of the individual light guiding means, and a plurality of light sources 5 adapted to the spectral types of the fixed stars are used.

In FIG. 1, reference sign 1 denotes a projection cylinder 1 housing a fixed-star template 2 and a projection lens 3. In the embodiment, the plurality of the light sources 5 with different color temperatures or color tones (LED lamps in this embodiment) are housed in the projection cylinder. Optical fibers 4 are used as light guiding means to divide light emitted from each light source among the corresponding spectral types of the individual fixed stars of the fixed-star template 2.

In this case, the shared use of a single light source 5 among a plurality of optical fibers 9 assigned to the same color temperature or color tone of light to be emitted reduces the number of light sources.

A plurality of luminous fluxes of different color temperatures or color tones may be generated by combined colors of a plurality of different emission colors of light sources, which is not shown.

FIG. 2 is a second embodiment of a fixed-star projection cylinder according to the present invention. In the embodiment, the light sources housed in the projection cylinder in the first embodiment are detached from the fixed-star projection cylinder and placed at a distance from it.

In FIG. 2, reference sign 10 denotes the projection cylinder, 12 denotes a fixed-star projection template and 13 denotes a projection lens. A plurality of light sources 16 differing in color temperature or color tone are housed in a casing 15. Optical fibers 17 extending to the projection cylinder and optical fibers 14 extending in the projection cylinder are used as light guiding means to divide light emitted from each light source among the corresponding spectral types of the individual fixed stars of the fixed-star template 12.

In this embodiment, as in the case of the first embodiment, a single light source 15 is shared among a plurality of the optical fibers 14 assigned to the same color temperature or color tone of light to be emitted. The common use in the projection cylinder is possible 4. Also, since the light sources are placed outside the projection cylinder, a single light source can be shared among a plurality of projection cylinders. In FIG. 2, reference sign 17 denotes an optical fiber extending to another projection cylinder in this case.

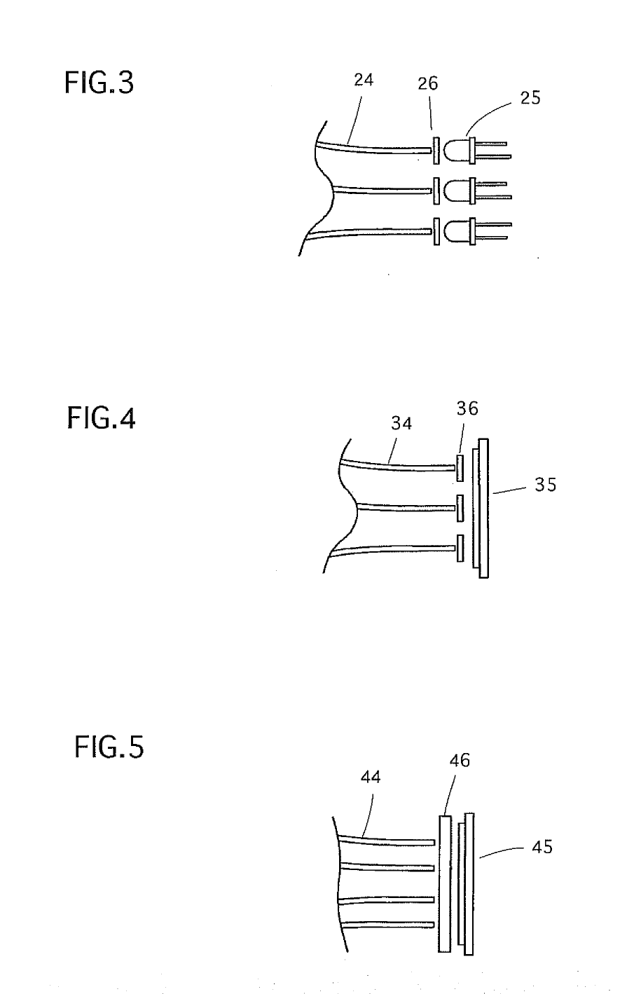

FIG. 3 is a view showing a third embodiment of a fixed-star projection cylinder according to the present invention. In the embodiment, a plurality of light sources 25 is for the same color. A filter 26 for passage or attenuation of light of a specific wavelength is interposed between the entry end face of the optical fiber 26 and the light source in order to generate a plurality of luminous fluxes differing in color temperature or color tone.

As a result, in the embodiment a reduction in the number of types of the light sources can be achieved.

FIG. 4 is a view showing a fourth embodiment of a fixed-star projection cylinder according to the present invention. In the embodiment, a filter 36 for passage or attenuation of light of a specific wavelength is interposed between the light source and the entry end face of an optical fiber 34 extending to the fixed-star template in order to generate a plurality of luminous fluxes differing in color temperature or color tone. Therefore, a plurality of the light sources are replaced with the light source 35 as a plane light source for a single color.

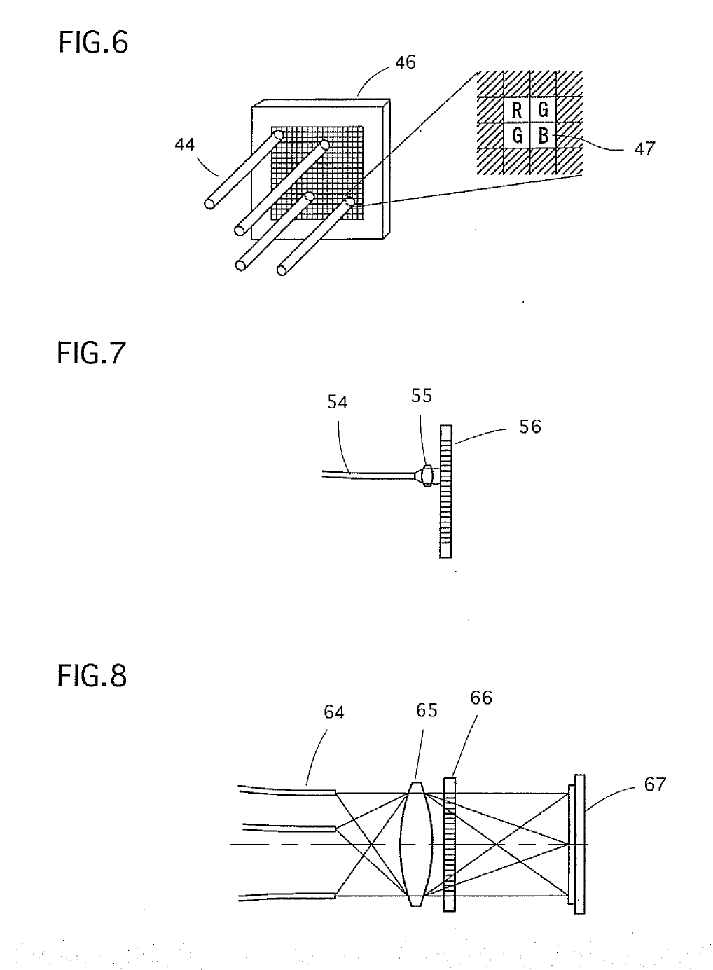

FIGS. 5 and 6 are views showing a fifth embodiment of a fixed-star projection cylinder according to the present invention. In the embodiment, a transmissive color liquid crystal panel 46 is used as a filter interposed between a light source 45 (plane light source in this embodiment) and the entry end face of an optical fiber 44 extending to the fixed-star template. In this case, a set of nearby pixels 97 on the liquid crystal panel is designed to provide a single color, so that the entry end face of each individual optical fiber 44 is placed to face the set of nearby pixels.

As described in the embodiment, the use of the transmissive color liquid crystal panel to provide different colors makes it possible to adjustably vary the color and the intensity as well as to significantly increase the number of representable colors. In addition, reproduction of a variable star and/or of changes in color and/or brightness made by stellar evolution is made possible.

FIG. 7 is a view showing a sixth embodiment of a fixed-star projection cylinder according to the present invention. In the arrangement of a transmissive color liquid crystal panel 56 through which light emitted from a light source (not shown) passes, each individual pixel passes through three, red, green and blue, colors. For this reason, a need arises to manage a group of a plurality of pixels (a set of nearby pixels) as a single color. For that purpose, a condenser optical system including lens and/or the like is placed at a preceding stage of the light guiding means so that the light of the plurality of pixels is guided by the light guiding means. In the embodiment, each of the condenser lenses 55 is placed between an entry end of each of the optical fibers 59 and each of the sets of nearby pixels of the transmissive color liquid crystal panel 56.

FIG. 8 is a view showing a seventh embodiment of a fixed-star projection cylinder according to the present invention. In the embodiment, a condenser lens 55 is placed between entry end faces of optical fibers 64 and a transmissive color liquid crystal panel 66. Reference sign 67 in FIG. 8 denotes a light source.

In the aforementioned embodiments, individual fixed-star images are projected onto a screen through a projection lens by light traveling from individual exit end faces of light guiding means to pass through individual light transmissive portions of a fixed-star projection template arranged corresponding to positions of fixed stars. In another way, individual fixed-star images may be projected onto a screen through a projection lens by light traveling from individual exit end faces of light guiding means arranged corresponding to estimated positions of fixed stars.

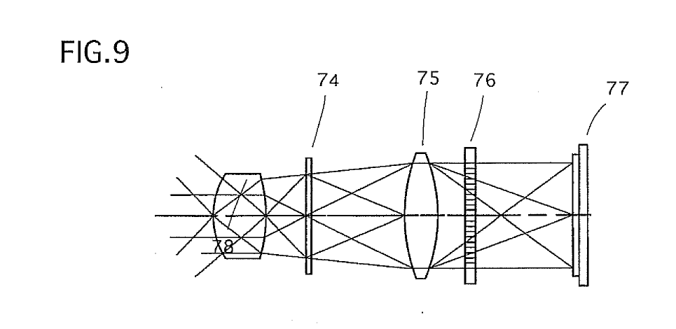

FIG. 9 is a view showing an eighth embodiment of a fixed-star projection cylinder according to the present invention. In the embodiment, a condenser lens 75, instead of the optical fibers, is placed between a projection template 74 and a transmissive color liquid crystal panel 76 to be used as light guiding means. Positions of pixels to be used on the transmissive color liquid crystal panel are appropriately set in order to guide light directly to the fixed-star template. In FIG. 9 reference sign 77 denotes a light source and reference sign 78 denotes a projection lens.

### REFERENCE SIGN LIST

1 Projection cylinder
2 Fixed-star template
3 projection lens
4 Optical fiber
5 Light source

1. A fixed-star projection cylinder for a planetarium to project individual fixed-star images onto a screen through a projection lens by either light traveling from exit end faces of individual light guiding means to pass through individual light transmissive portions of a fixed-star projection template arranged corresponding to positions of fixed stars or light traveling from exit end faces of individual light guiding means arranged corresponding to positions of fixed stars, wherein a spectral type is defined for each individual fixed-star image to be projected, and a plurality of types of light differing in either color temperature or color tone are emitted from the exit end faces of the individual light guiding means for reproduction of colors based on the defined spectral types in projection.

2. The fixed-star projection cylinder according to claim 1, wherein optical fibers are used as the light guiding means.

3. The fixed-star projection cylinder according to claim 1 or 2, wherein means is designed to guide lights emitted from a plurality of light sources with either different color temperatures or different color tones from the entry end faces of the individual light guiding means to emit a plurality of types of light with either different color temperatures or different color tones from the exit end faces of the individual light guiding means.

4. The fixed-star projection cylinder according to claim 3, wherein a plurality of the light sources with either different color temperatures or different color tones are placed in the fixed-star projection cylinder.

5. The fixed-star projection cylinder according to claim 3, wherein a plurality of the light sources with either different color temperatures or different color tones are placed outside the fixed-star projection cylinder.

6. The fixed-star projection cylinder according to any of claims 3 to 5, wherein a single light source is shared among a plurality of the light guiding means assigned to the same color temperature or color tone of light to be emitted in either the same fixed-star projection cylinder or a different fixed-star projection cylinder.

7. The fixed-star projection cylinder according to any of claims 3 to 6, wherein a plurality of luminous fluxes of either different color temperatures or different color tones are generated by combined colors of a plurality of different emission colors of the light sources.

8. The fixed-star projection cylinder according to claim 7, wherein the fixed-star projection cylinder is capable of individually varying luminance intensities of a plurality of the light sources for creation of the combined colors.

9. The fixed-star projection cylinder according to claim 1 or 2, wherein a filter for either passage or attenuation of light of a specific wavelength is placed between a light source and the entry end face of the light guiding means to serve as means for emitting a plurality of the types of light differing in either color temperature or color tone from the exit end faces of the individual light guiding means.

10. The fixed-star projection-cylinder according to claim 8, wherein a transmissive color liquid crystal panel is used as a filter for either passage or attenuation of light of a specific wavelength by controlling sets of nearby pixels on the transmissive color liquid crystal panel, each set of nearby pixels being assigned to a color.

11. The fixed-star projection cylinder according to claim 10, wherein the fixed-star projection cylinder is capable of controlling transmittance of the sets of nearby pixels on the transmissive color liquid crystal panel as required.
